(19) United States
(12) Patent Application Publication
(10) Pub. No.: US 2026/0021810 A1
(43) Pub. Date: Jan. 22, 2026

(54) VEHICLE DRIVING SUPPORT DEVICE, VEHICLE DRIVING SUPPORT METHOD, AND STORAGE MEDIUM

(71) Applicants: TOYOTA JIDOSHA KABUSHIKI KAISHA, Toyota-shi (JP); DENSO CORPORATION, Kariya-city (JP)

(72) Inventor: Hayato SHIRAI, Tagata-gun (JP)

(73) Assignees: TOYOTA JIDOSHA KABUSHIKI KAISHA, Toyota-shi (JP); DENSO CORPORATION, Kariya-city (JP)

(21) Appl. No.: 19/249,378

(22) Filed: Jun. 25, 2025

(30) Foreign Application Priority Data
Jul. 16, 2024 (JP) 2024-113368

(51) Int. Cl. B60W 30/165; B60W 30/18; B60W 50/00

(52) U.S. Cl. CPC B60W 30/165; B60W 30/18072; B60W 50/0097; B60W 2050/0083; B60W 2554/802

(57) ABSTRACT

A vehicle driving support device allows a vehicle to travel such that an inter-vehicle distance between the vehicle and a preceding vehicle falls within a predetermined range by repeatedly powering and coasting the vehicle while following travel control is executed. The vehicle driving support device sets a lower limit value of the predetermined range as a target inter-vehicle distance while the following travel control is executed, predicts as a minimum inter-vehicle distance a minimum value of the inter-vehicle distance after the vehicle starts coasting at a current point in time when the vehicle is powered due to the following travel control, and starts coasting the vehicle when the minimum inter-vehicle distance is equal to or shorter than the target inter-vehicle distance. The minimum inter-vehicle distance is predicted to be a shorter distance when a size of the preceding vehicle is large than when that of the preceding vehicle is small.

### CROSS-REFERENCE TO RELATED APPLICATION

This application claims priority to Japanese Patent Application No. 2024-113368 filed on Jul. 16, 2024. The disclosure of the above-identified application, including the specification, drawings, and claims, is incorporated by reference herein in its entirety.

### BACKGROUND

### 1. Technical Field

The present disclosure relates to a vehicle driving support device, a vehicle driving support method, and a storage medium.

### 2. Description of Related Art

Following travel control is known that allows an own vehicle to travel while the own vehicle follows a preceding vehicle. A vehicle driving support device is also known that allows the own vehicle to travel such that the inter-vehicle distance between the own vehicle and the preceding vehicle falls within a predetermined range by repeatedly powering and coasting the own vehicle while such following travel control is executed. Further, a vehicle driving support device is known that is configured to decelerate the own vehicle when a brake pedal is depressed while the own vehicle is coasting during execution of the following travel control (see, for example, Japanese Patent No. 6577668 (JP 6577668 B)).

### SUMMARY

The own vehicle approaches the preceding vehicle immediately after the travel state of the own vehicle is switched from a powering state to a coasting state while the above-mentioned following travel control is executed. At this time, when the preceding vehicle is a large-sized vehicle, air resistance force to the own vehicle is small. Therefore, the own vehicle approaches the preceding vehicle more. At this time, when a driver of the own vehicle feels that the own vehicle is getting too close to the preceding vehicle and depresses the brake pedal, the above-mentioned conventional vehicle driving support device will cause the own vehicle to decelerate. Therefore, energy efficiency related to traveling of the own vehicle decreases accordingly.

An object of the present disclosure is to provide a vehicle driving support device, a vehicle driving support method, and a storage medium that can restrain an own vehicle from approaching too close to a preceding vehicle after the own vehicle starts coasting while following travel control is executed.

The vehicle driving support device according to the present disclosure includes a control device that executes following travel control that allows an own vehicle to travel while the own vehicle follows a preceding vehicle. The control device is configured to allow the own vehicle to travel such that an inter-vehicle distance between the own vehicle and the preceding vehicle falls within a predetermined range by repeatedly powering and coasting the own vehicle while the following travel control is executed. Further, the control device is configured to set a lower limit value of the predetermined range as a target inter-vehicle distance while the following travel control is executed, predict as a minimum inter-vehicle distance a minimum value of the inter-vehicle distance after the own vehicle starts coasting at a current point in time when the own vehicle is powered due to the following travel control, and start coasting the own vehicle when the minimum inter-vehicle distance is equal to or shorter than the target inter-vehicle distance. Furthermore, the minimum inter-vehicle distance is predicted to be a shorter distance when the size of the preceding vehicle is large than when the size of the preceding vehicle is small.

When the own vehicle starts coasting, the acceleration of the own vehicle decreases. However, at the point in time when the own vehicle starts coasting, the acceleration of the own vehicle has a positive value. Therefore, the own vehicle approaches the preceding vehicle for a short period of time after the own vehicle starts coasting. The smaller the air resistance force to the own vehicle, the greater the degree to which the own vehicle approaches the preceding vehicle. Here, the air resistance force to the own vehicle is smaller as the size of the preceding vehicle is larger.

According to the vehicle driving support device of the present disclosure, the minimum inter-vehicle distance is predicted by taking the size of the preceding vehicle into consideration. That is, the minimum inter-vehicle distance is predicted by taking the effect of reducing the air resistance force to the own vehicle by the preceding vehicle into consideration. The timing for starting coasting of the own vehicle is determined using this minimum inter-vehicle distance. Therefore, it is possible to restrain the own vehicle from approaching too close to the preceding vehicle after the own vehicle starts coasting.

In the vehicle driving support device according to the present disclosure, the minimum inter-vehicle distance may be predicted to be a shorter distance when the size of the preceding vehicle is large than when the size of the preceding vehicle is small, and the minimum inter-vehicle distance may be predicted to be a shorter distance when the target inter-vehicle distance is short than when the target inter-vehicle distance is long.

The air resistance force to the own vehicle is smaller as the size of the preceding vehicle is larger, and is smaller as the target inter-vehicle distance is shorter.

According to the vehicle driving support device of the present disclosure, the minimum inter-vehicle distance is predicted by taking the size of the preceding vehicle and the target inter-vehicle distance into consideration. That is, the minimum inter-vehicle distance is predicted by taking the effect of reducing the air resistance force to the own vehicle by the preceding vehicle into consideration. The timing for starting coasting of the own vehicle is determined using this minimum inter-vehicle distance. Therefore, it is possible to restrain the own vehicle from approaching too close to the preceding vehicle after the own vehicle starts coasting.

Further, in the vehicle driving support device according to the present disclosure, the control device may be configured to start powering the own vehicle when the inter-vehicle distance reaches an upper limit value of the predetermined range while the own vehicle is coasting due to the following travel control.

According to the vehicle driving support device of the present disclosure, it is possible to start powering the own vehicle at an appropriate timing.

A vehicle driving support method according to the present disclosure is a method that executes following travel control that allows an own vehicle to travel while the own vehicle follows a preceding vehicle. The method allows the own vehicle to travel such that an inter-vehicle distance between the own vehicle and the preceding vehicle falls within a predetermined range by repeatedly powering and coasting the own vehicle while the following travel control is executed. The vehicle driving support method according to the present disclosure includes: setting a lower limit value of the predetermined range as a target inter-vehicle distance while the following travel control is executed; predicting as a minimum inter-vehicle distance a minimum value of the inter-vehicle distance after the own vehicle starts coasting at a current point in time when the own vehicle is powered due to the following travel control, and starting coasting the own vehicle when the minimum inter-vehicle distance is equal to or shorter than the target inter-vehicle distance; and predicting the minimum inter-vehicle distance to be a shorter distance when a size of the preceding vehicle is large than when the size of the preceding vehicle is small.

Due to the reason described above, according to the vehicle driving support method of the present disclosure, it is possible to restrain the own vehicle from approaching too close to the preceding vehicle after the own vehicle starts coasting.

A storage medium storing a vehicle driving support program according to the present disclosure is a storage medium storing a program that executes following travel control that allows an own vehicle to travel while the own vehicle follows a preceding vehicle. The program allows the own vehicle to travel such that an inter-vehicle distance between the own vehicle and the preceding vehicle falls within a predetermined range by repeatedly powering and coasting the own vehicle while the following travel control is executed. The vehicle driving support program stored in the storage medium according to the present disclosure is configured to: set a lower limit value of the predetermined range as a target inter-vehicle distance while the following travel control is executed; predict as a minimum inter-vehicle distance a minimum value of the inter-vehicle distance after the own vehicle starts coasting at a current point in time when the own vehicle is powered due to the following travel control, and start coasting the own vehicle when the minimum inter-vehicle distance is equal to or shorter than the target inter-vehicle distance; and predict the minimum inter-vehicle distance to be a shorter distance when a size of the preceding vehicle is large than when the size of the preceding vehicle is small.

Due to the reason described above, according to the storage medium of the present disclosure, it is possible to restrain the own vehicle from approaching too close to the preceding vehicle after the own vehicle starts coasting.

The components of the present disclosure are not limited to the embodiment of the present disclosure described later with reference to the drawings. Other objects, other features, and accompanying advantages of the present disclosure will be readily understood from the description of the embodiment of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a vehicle driving support device according to an embodiment of the present disclosure;

FIG. 2 is a diagram showing an own vehicle and a preceding vehicle;

FIG. 3 is a flowchart showing a routine executed by the vehicle driving support device according to the embodiment of the present disclosure; and

FIG. 4 is a flowchart showing a routine executed by the vehicle driving support device according to the embodiment of the present disclosure.

### DETAILED DESCRIPTION OF EMBODIMENTS

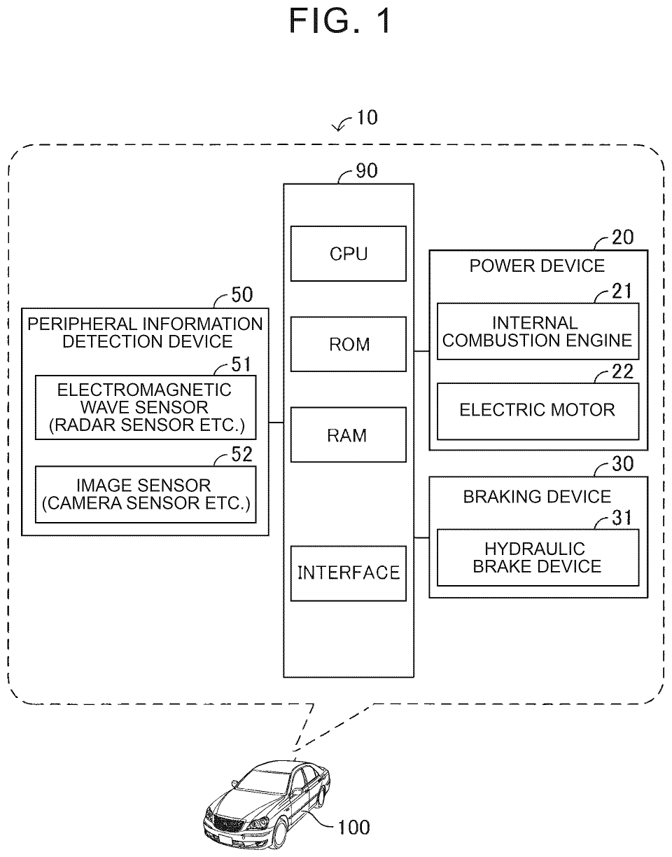

Hereinafter, a vehicle driving support device, a vehicle driving support method, and a storage medium according to an embodiment of the present disclosure will be described with reference to the drawings. In FIG. 1, a vehicle driving support device 10 according to the embodiment of the present disclosure is shown.

The vehicle driving support device 10 is mounted on an own vehicle 100. Hereinafter, the vehicle driving support device 10 will be described using a case as an example that an operator of the own vehicle 100 is a person who gets in the own vehicle 100 and drives the own vehicle 100 (that is, a driver of the own vehicle 100). However, the operator of the own vehicle 100 may be a person who drives the own vehicle 100 remotely without getting in the own vehicle 100 (that is, a remote operator of the own vehicle 100). The present disclosure is also applicable to vehicles that travel by autonomous driving without needing a driver or a remote operator to drive the vehicles.

As shown in FIG. 1, the vehicle driving support device 10 includes an electronic control unit (ECU) 90 as a control device. The ECU 90 includes a microcomputer as a main part. The microcomputer includes a central processing unit (CPU), a storage medium such as a read-only memory (ROM), a random access memory (RAM), and a non-volatile memory, an interface, and the like. The CPU implements various functions by executing instructions, programs, or routines stored in the storage medium. In particular, in this example, the vehicle driving support device 10 stores programs for implementing various controls executed by the vehicle driving support device 10 in the storage medium.

In this example, the vehicle driving support device 10 includes only one ECU 90. However, the vehicle driving support device 10 may be configured to include a plurality of ECUs such that the functions of the vehicle driving support device 10 described below are divided among the ECUs. Further, the vehicle driving support device 10 may be configured to be able to update the programs stored in the storage medium by wireless communication with an external device (for example, Internet communication).

The own vehicle 100 is equipped with a power device 20, a braking device 30, and a peripheral information detection device 50.

The power device 20 is a device that generates power to be applied to the own vehicle 100 (particularly, drive wheels of the own vehicle 100). In this example, the power device 20 includes an internal combustion engine 21 and an electric motor 22. The power device 20 is electrically connected to the ECU 90. The vehicle driving support device 10 is able to control the power applied to the own vehicle 100 by controlling the operation of the internal combustion engine 21 and the electric motor 22.

The braking device 30 is a device that applies braking force to the own vehicle 100 (particularly, wheels of the own vehicle 100). In this example, the braking device 30 includes a hydraulic brake device 31. The braking device 30 is electrically connected to the ECU 90. The vehicle driving support device 10 is able to control the braking force applied to the own vehicle 100 by controlling the operation of the hydraulic brake device 31.

The peripheral information detection device 50 is a device that detects peripheral information of the own vehicle 100. In this example, the peripheral information detection device 50 includes an electromagnetic wave sensor 51 and an image sensor 52. The peripheral information detection device 50 is electrically connected to the ECU 90. The electromagnetic wave sensor 51 is, for example, a radar sensor such as millimeter wave radar. The vehicle driving support device 10 acquires information related to an object that is present around the own vehicle 100 as peripheral information IS, by the electromagnetic wave sensor 51. Further, the image sensor 52 is, for example, a camera sensor. The vehicle driving support device 10 acquires image information related to the surroundings of the own vehicle 100 as peripheral information IS, by the image sensor 52.

### Operation of Vehicle Driving Support Device

Next, the operation of the vehicle driving support device 10 will be described. The vehicle driving support device 10 is configured to execute following travel control when execution of the following travel control is requested. On the other hand, the vehicle driving support device 10 is configured to stop the following travel control when the stop of the following travel control is requested.

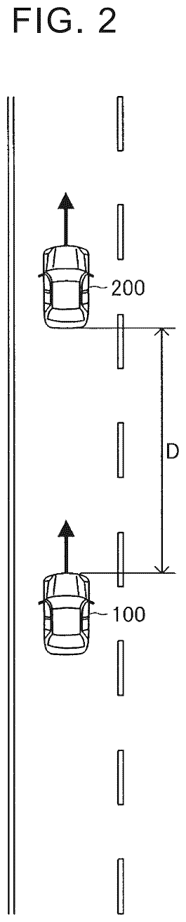

The following travel control is, as shown in FIG. 2, one of autonomous driving controls that allows the own vehicle 100 to travel while the own vehicle 100 follows a preceding vehicle 200. In other words, the following travel control is one of the autonomous driving controls that autonomously accelerates and decelerates the own vehicle 100 so that the own vehicle 100 follows the preceding vehicle 200. In this example, the following travel control includes a coasting mode and a powering mode as control modes. The preceding vehicle 200 is another vehicle traveling in an own vehicle traveling lane, and is ahead of the own vehicle 100 within a certain distance D200. The own vehicle traveling lane is the lane in which the own vehicle 100 is traveling. The preceding vehicle 200 is detected based on the peripheral information IS.

The coasting mode is a control mode in which the own vehicle 100 is decelerated by disconnecting the power device 20 from the drive wheels of the own vehicle 100 and coasting the own vehicle 100. The powering mode is a control mode in which the own vehicle 100 is accelerated. In particular, the powering mode is an optimal powering mode in which the power device 20 is operated with optimal energy efficiency to power the own vehicle 100.

When the following travel control is being executed in the powering mode, and when it is predicted that an inter-vehicle distance D will become shorter and a minimum inter-vehicle distance Dm described later will become equal to or shorter than a target inter-vehicle distance Dtgt, the control mode is switched from the powering mode to the coasting mode. That is, when the own vehicle 100 is powered due to the following travel control, and when the minimum inter-vehicle distance Dm described later is equal to or shorter than the target inter-vehicle distance Dtgt, the vehicle driving support device 10 starts coasting the own vehicle 100.

On the other hand, when the following travel control is being executed in the coasting mode, and when the inter-vehicle distance D becomes longer and reaches an upper limit inter-vehicle distance Du, the control mode is switched from the coasting mode to the powering mode. That is, when the own vehicle 100 is coasting due to the following travel control, and when the inter-vehicle distance D reaches an upper limit value of a predetermined range Rd, the vehicle driving support device 10 starts powering the own vehicle 100.

Therefore, in this example, a lower limit value of the predetermined range Rd is the target inter-vehicle distance Dtgt. Further, the upper limit value of the predetermined range Rd is the upper limit inter-vehicle distance Du. Therefore, the following travel control is control that allows the own vehicle 100 to travel such that the inter-vehicle distance D between the own vehicle 100 and the preceding vehicle 200 falls within the predetermined range Rd by repeatedly powering and coasting the own vehicle 100.

The inter-vehicle distance D is a distance between the preceding vehicle 200 and the own vehicle 100. The inter-vehicle distance D is acquired based on the peripheral information IS.

In this example, the target inter-vehicle distance Dtgt is a set inter-vehicle distance Dset. However, the target inter-vehicle distance Dtgt may be a distance that is longer than the set inter-vehicle distance Dset by a predetermined distance ΔDtgt. Further, the upper limit inter-vehicle distance Du is a distance that is longer than the set inter-vehicle distance Dset by a predetermined distance ΔDu. Here, the predetermined distance ΔDtgt is a very short distance. On the other hand, the predetermined distance ΔDu is considerably longer than the predetermined distance ΔDtgt. The set inter-vehicle distance Dset is preset by the driver of the own vehicle 100.

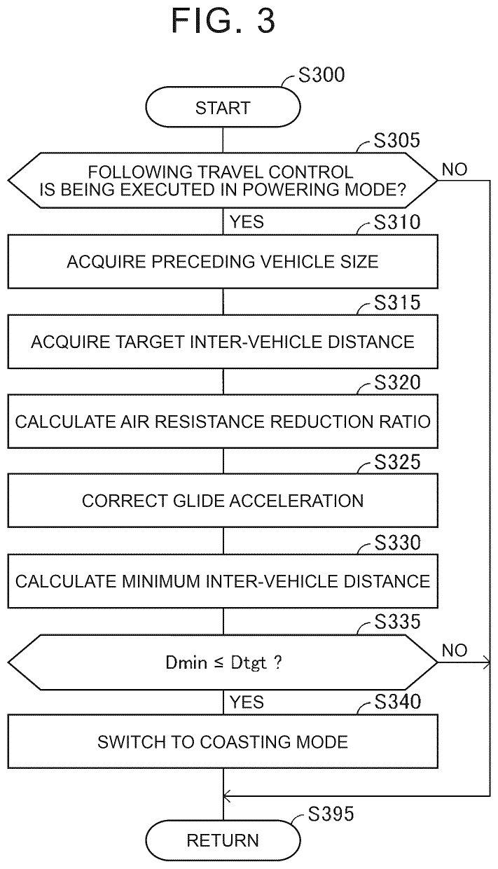

Further, the vehicle driving support device 10 executes a routine shown in FIG. 3 at predetermined calculation intervals. As a result, the own vehicle 100 is configured to start coasting when a predetermined condition is met while the following travel control is executed and the own vehicle 100 is powered.

At a predetermined timing, the vehicle driving support device 10 starts a process from step S300 of the routine shown in FIG. 3. Then, the vehicle driving support device 10 proceeds with the process to step S305 to determine whether the following travel control is being executed in the powering mode. That is, the vehicle driving support device 10 determines whether the own vehicle 100 is powered due to the following travel control.

When the vehicle driving support device 10 determines “No” in step S305, the vehicle driving support device 10 proceeds with the process directly to step S395 to temporarily end the processes of this routine. On the other hand, when the vehicle driving support device 10 determines “Yes” in step S305, the vehicle driving support device 10 proceeds with the process to step S310 to acquire a preceding vehicle size S.

In this example, the preceding vehicle size S is the size of the preceding vehicle 200. In particular, the preceding vehicle size S is the area of a rear end portion of the preceding vehicle 200 when the rear end portion is cut by a vertical plane perpendicular to the front-rear direction of the preceding vehicle 200. Therefore, the preceding vehicle size S is larger for a large truck than for an ordinary passenger vehicle. The preceding vehicle size S is acquired based on the peripheral information IS.

Next, the vehicle driving support device 10 proceeds with the process to step S315 to acquire the target inter-vehicle distance Dtgt. Next, the vehicle driving support device 10 proceeds with the process to step S320 to acquire an air resistance reduction ratio R.

The air resistance reduction ratio R represents a ratio at which the air resistance force to the own vehicle 100 is reduced by the preceding vehicle 200, assuming that the air resistance force to the own vehicle 100 is “100” when the preceding vehicle 200 is not present. The air resistance reduction ratio R is acquired as a larger value when the preceding vehicle size S is large than when the preceding vehicle size S is small. Further, the air resistance reduction ratio R is acquired as a larger value when the target inter-vehicle distance Dtgt is short than when the target inter-vehicle distance Dtgt is long. In particular, the air resistance reduction ratio R is acquired as a larger value as the preceding vehicle size S is larger. Further, the air resistance reduction ratio R is acquired as a larger value as the target inter-vehicle distance Dtgt is shorter. The vehicle driving support device 10 stores a map of the air resistance reduction ratio R that has the preceding vehicle size S and the target inter-vehicle distance Dtgt as arguments. The vehicle driving support device 10 acquires the air resistance reduction ratio R by applying the preceding vehicle size S and the target inter-vehicle distance Dtgt to the map.

Next, the vehicle driving support device 10 proceeds with the process to step S325 to acquire glide acceleration G.

The glide acceleration G is calculated by the following equation 1, using air resistance force Fa, rolling resistance force Fr, gradient resistance force Fg, and vehicle weight Wego. The air resistance force Fa, the rolling resistance force Fr, and the gradient resistance force Fg are able to be calculated by the following equations 2, 3, and 4, respectively, using the air resistance reduction ratio R, an own vehicle speed Vego, and gravitational acceleration g and a road gradient θ. The vehicle weight Wego is the weight of the own vehicle 100. The own vehicle speed Vego is the travel speed of the own vehicle 100. The road gradient θ is the gradient of the road on which the own vehicle 100 is traveling. The symbol Ca is the air resistance coefficient. The symbols Cr_1 and Cr_2 are rolling resistance coefficients.

$$G = ( Fa + Fr + Fg ) / Wego \qquad ( 1 )$$

$$Fa = Ca \cdot {Vego}^{2} \cdot ( 1 - R / 100 ) \qquad ( 2 )$$

$$Fr = Cr\_ 1 \cdot Vego + Cr\_ 2 \qquad ( 3 )$$

$$Fg = Wego \cdot g \cdot sin θ \qquad ( 4 )$$

Next, the vehicle driving support device 10 proceeds with the process to step S330 to calculate the minimum inter-vehicle distance Dm.

When the own vehicle 100 starts coasting, the acceleration of the own vehicle 100 decreases at the glide acceleration G. However, at the point in time when the own vehicle 100 starts coasting, the acceleration of the own vehicle 100 has a positive value. Therefore, the own vehicle 100 approaches the preceding vehicle 200 for a short period of time after the own vehicle 100 starts coasting. The smaller the air resistance force to the own vehicle 100, the greater the degree to which the own vehicle 100 approaches the preceding vehicle 200. Here, the air resistance force to the own vehicle 100 is smaller as the size of the preceding vehicle 200 is larger, and is smaller as the target inter-vehicle distance Dtgt is shorter.

The minimum inter-vehicle distance Dm is the minimum value of the inter-vehicle distance D predicted taking such a situation into consideration. That is, the minimum inter-vehicle distance Dm is a predicted value of the inter-vehicle distance D when the own vehicle 100 is closest to the preceding vehicle 200 after the own vehicle 100 starts coasting at the current point in time. In other words, the minimum inter-vehicle distance Dm is the predicted value of the inter-vehicle distance D at the point in time when the acceleration of the own vehicle 100 decreases at the glide acceleration G and becomes zero after the own vehicle 100 starts coasting at the current point in time.

The vehicle driving support device 10 calculates the minimum inter-vehicle distance Dm using the glide acceleration G and the current acceleration of the own vehicle 100.

Therefore, in this example, the minimum inter-vehicle distance Dm is acquired as a shorter distance when the preceding vehicle size S is large than when the preceding vehicle size S is small. Further, the minimum inter-vehicle distance Dm is acquired as a shorter distance when the target inter-vehicle distance Dtgt is short than when the target inter-vehicle distance Dtgt is long. In particular, the minimum inter-vehicle distance Dm is acquired as a shorter distance as the preceding vehicle size S is larger. Further, the minimum inter-vehicle distance Dm is acquired as a shorter distance as the target inter-vehicle distance Dtgt is shorter.

In this example, the minimum inter-vehicle distance Dm is calculated by taking both the preceding vehicle size S and the target inter-vehicle distance Dtgt into consideration. However, the minimum inter-vehicle distance Dm may also be calculated by taking only one of the preceding vehicle size S and the target inter-vehicle distance Dtgt into consideration.

Next, the vehicle driving support device 10 proceeds with the process to step S335 to determine whether the minimum inter-vehicle distance Dm is equal to or shorter than the target inter-vehicle distance Dtgt. When the vehicle driving support device 10 determines “No” in step S335, the vehicle driving support device 10 proceeds with the process directly to step S395 to temporarily end the processes of this routine. On the other hand, when the vehicle driving support device 10 determines “Yes” in step S335, the vehicle driving support device 10 proceeds with the process to step S340 to end powering of the own vehicle 100 and start coasting the own vehicle 100. That is, the vehicle driving support device 10 switches the control mode from the powering mode to the coasting mode. Subsequently, the vehicle driving support device 10 proceeds with the process to step S395 to temporarily end the processes of this routine.

According to the vehicle driving support device 10, the minimum inter-vehicle distance Dm is predicted by taking the preceding vehicle size S and the target inter-vehicle distance Dtgt into consideration. That is, the minimum inter-vehicle distance Dm is predicted by taking the effect of reducing the air resistance force to the own vehicle 100 by the preceding vehicle 200 into consideration. The timing for starting coasting of the own vehicle 100 is determined using this minimum inter-vehicle distance Dm. Therefore, it is possible to restrain the own vehicle 100 from approaching too close to the preceding vehicle 200 after the own vehicle 100 starts coasting.

The present disclosure is not limited to the above embodiment, and various modifications can be adopted within the scope of the present disclosure.

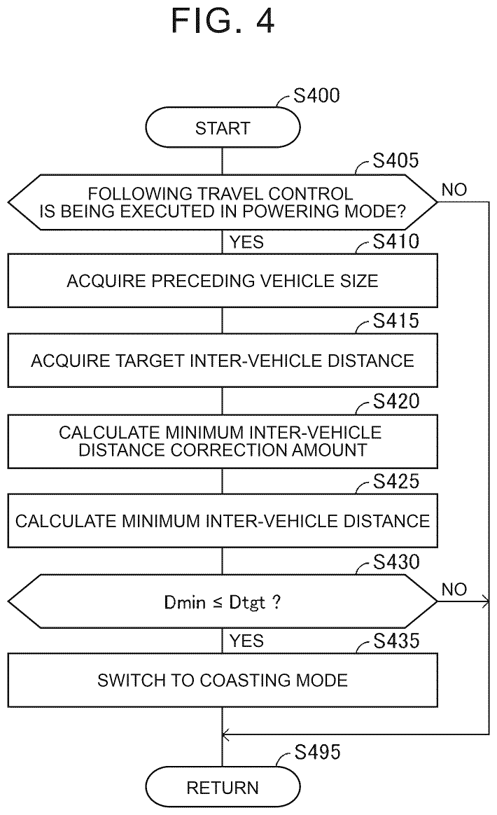

For example, the vehicle driving support device 10 may be configured to execute the routine shown in FIG. 4 instead of the routine shown in FIG. 3. In this case, at a predetermined timing, the vehicle driving support device 10 starts a process from step S400 of the routine shown in FIG. 4. Then, the vehicle driving support device 10 proceeds with the process to step S405 to determine whether the following travel control is being executed in the powering mode. When the vehicle driving support device 10 determines “No” in step S405, the vehicle driving support device 10 proceeds with the process directly to step S495 to temporarily end the processes of this routine. On the other hand, when the vehicle driving support device 10 determines “Yes” in step S405, the vehicle driving support device 10 proceeds with the process to step S410 to acquire the preceding vehicle size S.

Next, the vehicle driving support device 10 proceeds with the process to step S415 to acquire the target inter-vehicle distance Dtgt. Next, the vehicle driving support device 10 proceeds with the process to step S420 to acquire a minimum inter-vehicle distance correction amount ΔDc.

The minimum inter-vehicle distance Dm when there is the effect of reducing the air resistance of the own vehicle 100 by the preceding vehicle 200 is shorter than a reference inter-vehicle distance Ds. The reference inter-vehicle distance Ds is the minimum inter-vehicle distance Dm when there is no effect of reducing the air resistance of the own vehicle 100 by the preceding vehicle 200. The minimum inter-vehicle distance correction amount ΔDc is used to correct the reference inter-vehicle distance Ds to the minimum inter-vehicle distance Dm when there is the effect of reducing the air resistance of the own vehicle 100 by the preceding vehicle 200.

Therefore, the minimum inter-vehicle distance correction amount ΔDc is acquired as a larger value when the preceding vehicle size S is large than when the preceding vehicle size S is small. Further, the minimum inter-vehicle distance correction amount ΔDc is acquired as a larger value when the target inter-vehicle distance Dtgt is short than when the target inter-vehicle distance Dtgt is long. In particular, the minimum inter-vehicle distance correction amount ΔDc is acquired as a larger value as the preceding vehicle size S is larger. Further, the minimum inter-vehicle distance correction amount ΔDc is acquired as a larger value as the target inter-vehicle distance Dtgt is shorter. The vehicle driving support device 10 stores a map of the minimum inter-vehicle distance correction amount ΔDc that has the preceding vehicle size S and the target inter-vehicle distance Dtgt as arguments. The vehicle driving support device 10 acquires the minimum inter-vehicle distance correction amount ΔDc by applying the preceding vehicle size S and the target inter-vehicle distance Dtgt to the map.

Next, the vehicle driving support device 10 proceeds with the process to step S425 to calculate the minimum inter-vehicle distance Dm. The minimum inter-vehicle distance Dm here is calculated by subtracting the minimum inter-vehicle distance correction amount ΔDc from the reference inter-vehicle distance Ds (Dm=Ds−ΔDc). Therefore, also in this example, the minimum inter-vehicle distance Dm is acquired as a shorter distance when the preceding vehicle size S is large than when the preceding vehicle size S is small. Further, the minimum inter-vehicle distance Dm is acquired as a shorter distance when the target inter-vehicle distance Dtgt is short than when the target inter-vehicle distance Dtgt is long. In particular, the minimum inter-vehicle distance Dm is acquired as a shorter distance as the preceding vehicle size S is larger. Further, the minimum inter-vehicle distance Dm is acquired as a shorter distance as the target inter-vehicle distance Dtgt is shorter.

Next, the vehicle driving support device 10 proceeds with the process to step S430 to determine whether the minimum inter-vehicle distance Dm is equal to or shorter than the target inter-vehicle distance Dtgt. When the vehicle driving support device 10 determines “No” in step S430, the vehicle driving support device 10 proceeds with the process directly to step S495 to temporarily end the processes of this routine. On the other hand, when the vehicle driving support device 10 determines “Yes” in step S430, the vehicle driving support device 10 proceeds with the process to step S435 to end powering of the own vehicle 100 and start coasting the own vehicle 100. That is, the vehicle driving support device 10 switches the control mode from the powering mode to the coasting mode. Subsequently, the vehicle driving support device 10 proceeds with the process to step S495 to temporarily end the processes of this routine.

This also makes it possible to restrain the own vehicle 100 from approaching too close to the preceding vehicle 200 after the own vehicle 100 starts coasting.

What is claimed is:

1. A vehicle driving support device comprising a control device that executes following travel control that allows an own vehicle to travel while the own vehicle follows a preceding vehicle, the control device being configured to allow the own vehicle to travel such that an inter-vehicle distance between the own vehicle and the preceding vehicle falls within a predetermined range by repeatedly powering and coasting the own vehicle while the following travel control is executed, wherein:
the control device is configured to
set a lower limit value of the predetermined range as a target inter-vehicle distance while the following travel control is executed,
predict as a minimum inter-vehicle distance a minimum value of the inter-vehicle distance after the own vehicle starts coasting at a current point in time when the own vehicle is powered due to the following travel control, and start coasting the own vehicle when the minimum inter-vehicle distance is equal to or shorter than the target inter-vehicle distance; and
the minimum inter-vehicle distance is predicted to be a shorter distance when a size of the preceding vehicle is large than when the size of the preceding vehicle is small.

2. The vehicle driving support device according to claim 1, wherein the minimum inter-vehicle distance is predicted to be a shorter distance when the size of the preceding vehicle is large than when the size of the preceding vehicle is small, and the minimum inter-vehicle distance is predicted to be a shorter distance when the target inter-vehicle distance is short than when the target inter-vehicle distance is long.

3. The vehicle driving support device according to claim 1, wherein the control device is configured to start powering the own vehicle when the inter-vehicle distance reaches an upper limit value of the predetermined range while the own vehicle is coasting due to the following travel control.

4. A vehicle driving support method that executes following travel control that allows an own vehicle to travel while the own vehicle follows a preceding vehicle, the vehicle driving support method allowing the own vehicle to travel such that an inter-vehicle distance between the own vehicle and the preceding vehicle falls within a predetermined range by repeatedly powering and coasting the own vehicle while the following travel control is executed, the vehicle driving support method comprising:
setting a lower limit value of the predetermined range as a target inter-vehicle distance while the following travel control is executed;
predicting as a minimum inter-vehicle distance a minimum value of the inter-vehicle distance after the own vehicle starts coasting at a current point in time when the own vehicle is powered due to the following travel control, and starting coasting the own vehicle when the minimum inter-vehicle distance is equal to or shorter than the target inter-vehicle distance; and
predicting the minimum inter-vehicle distance to be a shorter distance when a size of the preceding vehicle is large than when the size of the preceding vehicle is small.

5. A non-transitory storage medium storing a vehicle driving support program that executes following travel control that allows an own vehicle to travel while the own vehicle follows a preceding vehicle, the vehicle driving support program allowing the own vehicle to travel such that an inter-vehicle distance between the own vehicle and the preceding vehicle falls within a predetermined range by repeatedly powering and coasting the own vehicle while the following travel control is executed, wherein the vehicle driving support program is configured to:
set a lower limit value of the predetermined range as a target inter-vehicle distance while the following travel control is executed;
predict as a minimum inter-vehicle distance a minimum value of the inter-vehicle distance after the own vehicle starts coasting at a current point in time when the own vehicle is powered due to the following travel control, and start coasting the own vehicle when the minimum inter-vehicle distance is equal to or shorter than the target inter-vehicle distance; and
predict the minimum inter-vehicle distance to be a shorter distance when a size of the preceding vehicle is large than when the size of the preceding vehicle is small.
